(19) United States
(12) Patent Application Publication
(10) Pub. No.: US 2017/0293500 A1
(43) Pub. Date: Oct. 12, 2017

(54) METHOD FOR OPTIMAL VM SELECTION FOR MULTI DATA CENTER VIRTUAL NETWORK FUNCTION DEPLOYMENT

(71) Applicant: Affirmed Networks Communications Technologies, Inc., Acton, MA (US)

(72) Inventors: Carlos Molina, Plano, TX (US); Kenton Perry Nickell, Frisco, TX (US); Haibo Qian, Frisco, TX (US); Fred Rink, Fairview, TX (US); Michael Anthony Brown, McKinney, TX (US)

(21) Appl. No.: 15/091,748

(22) Filed: Apr. 6, 2016

(51) Int. Cl. G06F 9/455

(52) U.S. Cl. CPC G06F 9/45558; G06F 2009/45595

(57) ABSTRACT

Example implementations involve a mechanism based on inter virtual machine (VM) communication to detect latency between VMs (Latency Detection Protocol) and peer nodes. The mechanism is used to optimize inter VM communication, by selecting a VM closest to the source; and also it is used to anchor an external connection to a VM which is closer to the external peer network function.

### BACKGROUND

### Field

The present application is directed to data centers, and more specifically, to virtual machines and virtual network functions deployed over one or more data centers.

### Related Art

In the related art, the methods of deployment of complex virtual network functions (VNFs) involve one or more data centers. Such VNFs are composed of virtual machines (VMs), which can be deployed on data centers spanning over multiple geographical regions to meet operator requirements related to redundancy, proximity to the peer network functions.

In such related art implementations, it is possible for the VNFs to have different sets of VMs personalities performing different processing functions. For example, a group of VMs can be configured for performing signaling transactions, while some other VMs are configured for performing user plane functions.

In related art complex VNF applications deployments on data centers, the application should be compatible with any underlying hardware (HW) platform. While achieving this objective, the VNF may not have information about the physical location of the VMs which are part of the VNF.

In related art design solutions, when a load balancer function needs to select a VM to place or continue the processing of the transaction, the load balancer functions can select VMs using round robin, load balancing traffic, and some other related art factor. Most of the related art protocols to distribute traffic are based on round robin and load balancing algorithms.

In related art, a configuration might be used in the load balancer function to select a VM which is co-located to the VM or external connection point. The configuration is provided manually to the system as a static configuration based on the proximity knowledge of the operator managing the system.

### SUMMARY

In example implementations, inter VM latency is added to the algorithm for selecting VMs to process a transaction, or for placing a session or for anchoring a peer network function. By adding delay as additional criteria to the selection of a VM, the VNF is able to reduce inter VM communication latency even under distributed deployments across multiple data centers. In example implementations, the systems thereby learn and determine the VM to use based on the delay algorithm, thereby eliminating the need for a manual and static configuration provided by an operator.

Furthermore, the inter VM latency information can be acquired via an algorithm allowing the VNF to learn the inter VM delay from real time data collected from the deployment environment. Self-optimizing algorithms can be utilized in example implementations when deployed on a multi-region data center environment.

Aspects of the present disclosure may include a system, which can involve a memory configured to store routing table information indicative of a plurality of interconnections between a plurality of virtual machines (VMs) managed by the system; and a processor, configured to calculate latency for each of the plurality of interconnections of the plurality of VMs; select ones of interconnections from the plurality of interconnections for each of the plurality of VMs to utilize an interconnection based on a ranking of the latency; and configure each of the plurality of VMs to utilize the selected ones of the plurality of interconnections.

Aspects of the present disclosure may include a method, which can include managing routing table information indicative of a plurality of interconnections between a plurality of virtual machines (VMs) managed by a system; calculating latency for each of the plurality of interconnections of the plurality of VMs; selecting ones of interconnections from the plurality of interconnections for each of the plurality of VMs to utilize an interconnection based on a ranking of the latency; and configuring each of the plurality of VMs to utilize the selected ones of the plurality of interconnections.

Aspects of the present disclosure may further include a non-transitory computer readable medium, storing instructions for executing a process, wherein the instructions can involve managing routing table information indicative of a plurality of interconnections between a plurality of virtual machines (VMs) managed by a system; calculating latency for each of the plurality of interconnections of the plurality of VMs; selecting ones of interconnections from the plurality of interconnections for each of the plurality of VMs to utilize an interconnection based on a ranking of the latency; and configuring each of the plurality of VMs to utilize the selected ones of the plurality of interconnections.

### BRIEF DESCRIPTION OF DRAWINGS

FIG. 1 illustrates an example implementation of a VNF with multiple VMs.

FIG. 2 illustrates a single VNF deployed across multiple data centers, in accordance with an example implementation.

FIG. 3 illustrates an example processing of an external message, in accordance with an example implementation.

FIG. 4 illustrates a flow diagram, in accordance with an example implementation.

FIG. 5 illustrates an example implementation of the system with a peer network function.

FIG. 6 illustrates an example scenario upon which example implementations may be applied.

FIG. 7 illustrates a flow diagram for an addition of a VM, in accordance with an example implementation.

FIG. 8 illustrates a flow diagram for a VM failure, in accordance with an example implementation.

FIG. 9 illustrates an example computing environment with an example computer device suitable for use in some example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application.

In the related art, the initial virtualized deployment does not consider delay from self-learned information for sessions and/or peer network node placement. The related art may implement delay protocols/algorithms that are applicable to lower layers (e.g. layer 2 and 3). However, none of the related art implementations utilize application delay information.

In example implementations, the same algorithm can be applied to discover the delay between the VNF and the peer nodes so as to assign a session to a VM closest to the peer node.

In example implementations, there is a mechanism based on inter VM communication to detect latency between VMs (Latency Detection Protocol) and peer nodes. The protocol is also used for external communication. The algorithm can be configured to keep track of latency metrics (e.g., min, max, average, rolling average, etc.). One example implementation can involve adding time stamp information regarding real time protocol (RTP) delay to the control messages. The end points will collect and process the delay information. The end points will periodically report to the centralized resource manager in order to update RTP for the different internal and external peer points.

In a highly distributed VNF, the connection to a peer network node can be placed and/or migrated on a VM with the lowest latency delay per the detection latency mechanism and from the results of the algorithms of the example implementations. The resulting benefit can include having specific VMs responsible for anchoring connection to peer network functions distributed geographically closer to the peer node. In addition, the VNF can be configured to utilize Latency based Optimization (VM placement based on optimal latency) for VM selection. Further, the outcome of the protocol and delay detection algorithm of example implementations can be used for VM selection within the VNF.

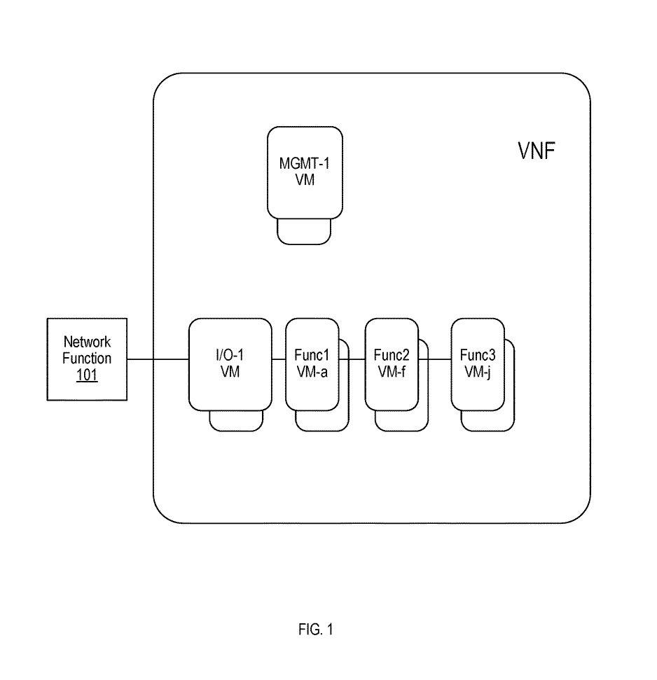

FIG. 1 illustrates an example implementation of a VNF with multiple VMs. A VNF will have multiple VMs which perform different functionalities. Input/Output (I/O) VMs (I/O-1) are for external communication; Func1, Func2 and Func3 are for distribution of functions that the VNF performs; and Management (MGMT) VMs (MGMT-1) are the operations, administration, maintenance, and resource management of the VNF. The MGMT VM handles the collection of data and processing of the proposed algorithm. The MGMT VM also distributes the output of the algorithm for the system/VMs to update routing tables. Network Function 101 performs a networking function between the network and the VNF.

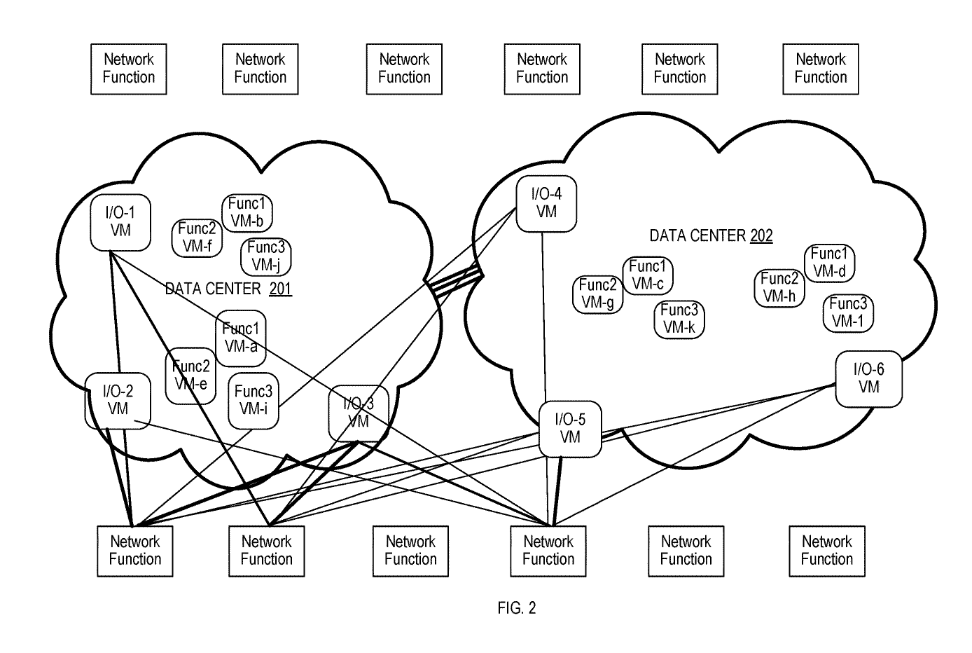

FIG. 2 illustrates a VNF deployed across multiple data centers, in accordance with an example implementation. A VNF that is composed of multiple types of virtual machines can be deployed across multiple data centers 201 and 202, as illustrated in FIG. 2. The VNF uses a set of input/output (I/O) VMs for external internet protocol (IP) connectivity purposes. The I/O VMs may indicate to the network the reachability of the same set of IP addresses. The external network function can favor the closest I/O VM based on the cost of routing. The bold lines of FIG. 2 represent lower cost links. Once an I/O VM receives a message from an external network function, the I/O VM can favor VMs that are closest to the I/O VM to process the message. In this context, “closest” can refer to VMs having the lowest delay.

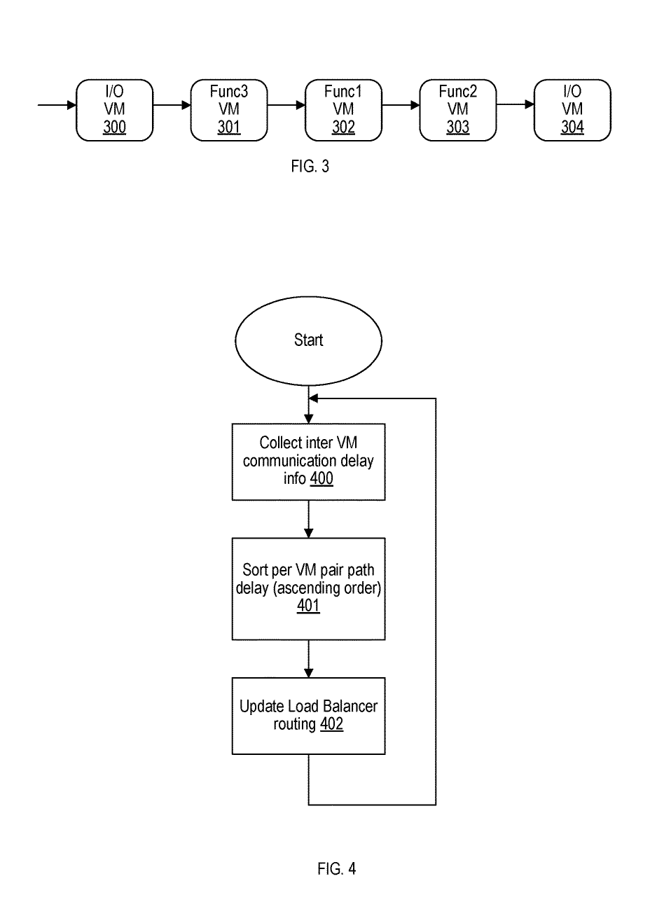

FIG. 3 illustrates an example processing of an external message, in accordance with an example implementation. Assume that the processing of one external message follows the path as illustrated in FIG. 3: I/O VM 300, Func 3 VM 301, Func 1 VM 302, Func 2 VM 303, and I/O VM 304. Further, assume that there is a full mesh connectivity between the VMs types (I/O VMs, Func1, Func2 and Func3) such that any FuncX VM can be selected to process the message. In example implementations, there is an algorithm that is developed for the VNF to learn the proximity (e.g., delay) to prefer the selection of a VM with shorter transmission delay rather than a VM with longer delay. Thus in example implementations, the algorithm will attempt to identify the VMs that are located within the same data center (which tend to have smaller delay) and the VMs that are remote to a different data center (which tend to have longer delay).

In example implementations, VMs within the same data center may communicate over one or two hops though local switches and using 1 Gbps (or higher) bandwidth, making the delay smaller. On the other hand, VMs that are located on different data centers may go through routers, which makes the transmission delay noticeably longer while still meeting the delay requirements of the inter VM traffic. The difference between the inter data center and intra data center delay can be significant enough for the algorithm to recognize the difference and for the algorithm to cluster the VMs in to groups of “local” or preferred VMs versus remote VMs.

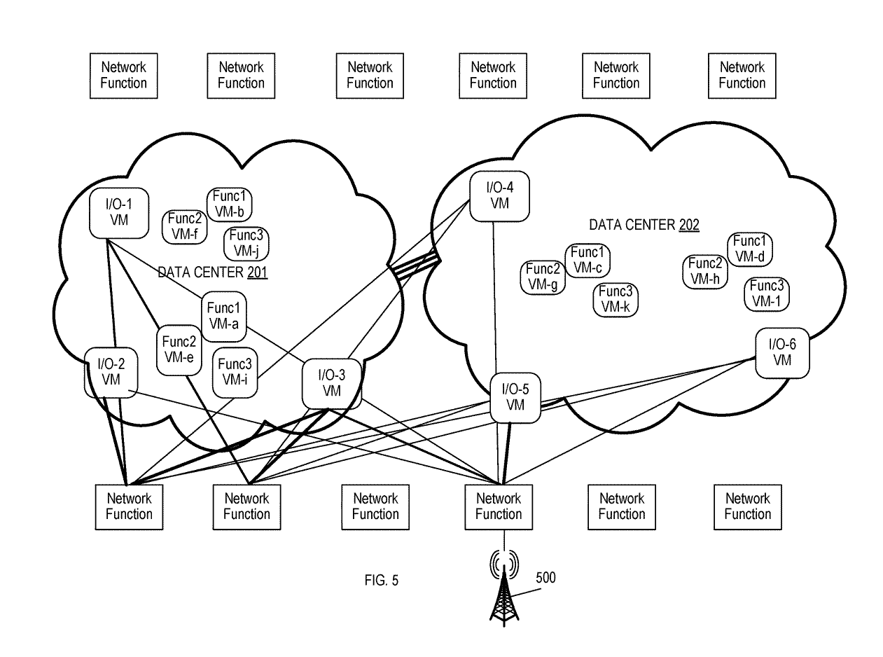

FIG. 4 illustrates a flow diagram, in accordance with an example implementation. In the proposed example, each of the Func 1 VMs will use a mechanism to measure, monitor and keep track of the delay between each Func 1 VM and the peers Func2 and Func3 VMs at 400. Examples of delay mechanisms include n “ping” traces with a repeat period depending on the desired implementation (e.g. 30 seconds). “n” is set such that there is enough data for the variance in the sample points to meet the desired implementation, or that there are enough data points for the delay to converge to a value within the collected interval. The flow at 400 can be executed by the MGMT VM by having the MGMT VM sending instructions to each of the Func VMs to issue a ping through a GET API operation. The VMs can obtain the results in terms of ping delay, or can also be in terms of differences in timestamps between exchanged messages to measure latency.

At 401, each VM can sort the destinations or peer VMs based on the smallest delay value. The sorting can also be conducted by the MGMT VM, which can collect the results from each of VMs in the form of extensible markup language indicating the peer pairs, the addresses, and the delays between peers as well as the packet loss. The results can also be in the form of timestamps of messages sent and received between peers, wherein the MGMT VM can determine the delay based on the differences in timestamps.

The resulting sorted list can be utilized as the load balancer table to update the load balancer routing at 402. Note that a second “sorting” factor could be load or utilization on the peer VMs. Each VM is configured to utilize the delay based routing table to select the peer VM to continue with the processing of the incoming message.

As an example, the following is the routing table information for Func 2 VM-e for the system of FIG. 2.
Destination: External Traffic
Preferred I/O VMs: I/O-1, I/O-2 and I/O-3
Preferred Func1 VMs: a, b
Preferred Func3 VMs: i, j

FIG. 5 illustrates an example implementation of the system with peer network function500. The substantially same concept is extended for the external communication I/O VMs. All the I/O VMs utilize n Ping traces to estimate the delay to external connections. For example, for a given peer network function 500, all I/O VMs (I/O-1, I/O-2, I/O-3. I/O-4, I/O-5, I/O-6), will apply the delay detection algorithm of FIG. 4 towards the peer network function 500. FIG. 5 illustrates an example implementation of the system with a peer network function500. After successful execution of the delay algorithm, the VNF will learn that I/O VMs I/O-5 is “closer” or present a smaller delay, followed by I/O-3 VM. Sessions that are initiated from the peer network function 500 will be moved to Func 1, Func2, and Func3 closer to I/O-5 first, followed by I/O-3.

Thus, in the example with an external peer network function 500, the MGMT VM can calculate latency for each of the plurality of interconnections between the plurality of VMs and the peer network function for the management of sessions initiated from the peer network function.

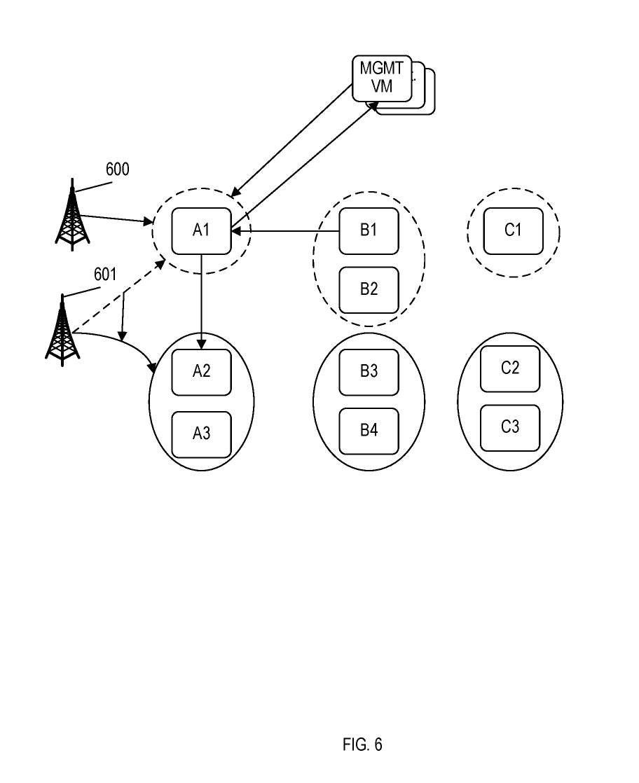

FIG. 6 illustrates an example scenario upon which example implementations may be applied. In the example of FIG. 6, there are two peer network functions 600 and 601 that are located at remote distances from each other. peer network function 600 is in proximity to the VMs A1, B1, B2 and C1 as indicated by the dashed line, which is managed by a data center near the peer network function 600. Peer network function 601 is in proximity to the VMs A2, A3, B3, B4, C2 and C3 as indicated in the solid line, which is managed by another data center near the peer network function 601. In the example of FIG. 6, the pathway for VM message processing proceeds from the A set of VMs to the B set of VMs and then to the C set of VMs.

As illustrated in FIG. 6, when a new external node needs to connect to the VNF, the VNF may not have information regarding the “location” of this external node. The connection request may be routed to any of the I/O VMs due to a routing algorithm (equal-cost multi-path routing for example) on the external network. The result is that that new connection is going to be placed on any given I/O VM. As a second aspect, the VNF/MGMT will order the I/O VMs to ping or calculate the delay to the new connection. In this example, peer network function 600 happens to be placed on a “correct” or optimal location based on delay. However, peer network function 601, was originally placed in A1, but the VNF learn that A2 is closer from delay point of view, therefore, the VNF/MGMT VM will move the anchor point of the peer network function from A1 to A2. Now the VM is placed on the optimal location.

Suppose VM A2, of FIG. 6, executes the flow of FIG. 4 to determine the preferred peer from the B set of VMs. Due to the physical location of A2 with respect to the location of the VMs of B3 and B4 as compared to the VMs of B1 and B2, the delay is smaller from B3 and B4 than from B1 and B2. The routing table information for VM A2 is determined to be as follows:

Next hop (peers):
Preferred peers
   B3
   B4
Alternate peers
   B1
   B2

The routing information for VM A2 can be provided as an update from the MGMT VM to VM A2 through extensible markup language or through other methods depending on the desired implementation.

In example implementations, the selection between B3 and B4 as well between B1 and B2 can be based on load distribution between B3 and B4, round robin or weighted round robin or by other methods depending on the desired implementation. The same implementation for the load distribution between B1 and B2 can also be utilized.

When VM A2 executes the flow at 401 from FIG. 4, the VM A2 will receive results that can be sent back to the MGMT VM for determining the routing table information. Suppose the MGMT VM send the command to all the VMs in the system to collect and report back the delay information for the peers. The following is an example for the data collected and reported from A2 VMs.

From A2 to B1:

admin@vnf-A2:˜$ ping 172.18.254.123

PING 172.18.254.123 (172.18.254.123) 56(84) bytes of data.

64 bytes from 172.18.254.123: icmp_req=1 tt1=64 time=0.510 ms

64 bytes from 172.18.254.123: icmp_req=2 tt1=64 time=0.237 ms

64 bytes from 172.18.254.123: icmp_req=3 tt1=64 time=0.256 ms

64 bytes from 172.18.254.123: icmp_req=4 tt1=64 time=0.307 ms

64 bytes from 172.18.254.123: icmp_req=5 tt1=64 time=0.282 ms

64 bytes from 172.18.254.123: icmp_req=6 tt1=64 time=0.205 ms

64 bytes from 172.18.254.123: icmp_req=7 tt1=64 time=0.273 ms

64 bytes from 172.18.254.123: icmp_req=8 tt1=64 time=0.240 ms

64 bytes from 172.18.254.123: icmp_req=9 tt1=64 time=0.233 ms

--- 172.18.254.123 ping statistics ---

9 packets transmitted, 9 received, 0% packet loss, time 7999 ms

rtt min/avg/max/mdev=0.205/0.282/0.510/0.087 ms

From A2 to B2:

admin@vnf-A2:˜$ ping 172.18.254.122

PING 172.18.254.122 (172.18.254.122) 56(84) bytes of data.

64 bytes from 172.18.254.122: icmp_req=1 tt1=64 time=0.525 ms

64 bytes from 172.18.254.122: icmp_req=2 tt1=64 time=0.331 ms

64 bytes from 172.18.254.122: icmp_req=3 tt1=64 time=0.233 ms

64 bytes from 172.18.254.122: icmp_req=4 tt1=64 time=0.275 ms

64 bytes from 172.18.254.122: icmp_req=5 tt1=64 time=0.335 ms

64 bytes from 172.18.254.122: icmp_req=6 tt1=64 time=0.282 ms

64 bytes from 172.18.254.122: icmp_req=7 tt1=64 time=0.209 ms

64 bytes from 172.18.254.122: icmp_req=8 tt1=64 time=0.324 ms

64 bytes from 172.18.254.122: icmp_req=9 tt1=64 time=0.299 ms

--- 172.18.254.122 ping statistics ---

9 packets transmitted, 9 received, 0% packet loss, time 7997 ms

rtt min/avg/max/mdev=0.209/0.312/0.525/0.087 ms

From A2 to B3:

admin@vnf-A2:˜$ ping 172.18.254.121

PING 172.18.254.121 (172.18.254.121) 56(84) bytes of data.

64 bytes from 172.18.254.121: icmp_req=1 tt1=64 time=0.090 ms

64 bytes from 172.18.254.121: icmp_req=2 tt1=64 time=0.120 ms

64 bytes from 172.18.254.121: icmp_req=3 tt1=64 time=0.077 ms

64 bytes from 172.18.254.121: icmp_req=4 tt1=64 time=0.079 ms

64 bytes from 172.18.254.121: icmp_req=5 tt1=64 time=0.088 ms

64 bytes from 172.18.254.121: icmp_req=6 tt1=64 time=0.081 ms

64 bytes from 172.18.254.121: icmp_req=7 tt1=64 time=0.077 ms

64 bytes from 172.18.254.121: icmp_req=8 tt1=64 time=0.074 ms

64 bytes from 172.18.254.121: icmp_req=9 tt1=64 time=0.083 ms

--- 172.18.254.121 ping statistics ---

9 packets transmitted, 9 received, 0% packet loss, time 7999 ms

rtt min/avg/max/mdev=0.074/0.085/0.120/0.013 ms

From A2 to B4:

admin@vnf-A2:˜$ ping 172.18.254.124

PING 172.18.254.124 (172.18.254.124) 56(84) bytes of data.

64 bytes from 172.18.254.124: icmp_req=1 tt1=64 time=0.107 ms

64 bytes from 172.18.254.124: icmp_req=2 tt1=64 time=0.032 ms

64 bytes from 172.18.254.124: icmp_req=3 tt1=64 time=0.041 ms

64 bytes from 172.18.254.124: icmp_req=4 tt1=64 time=0.037 ms

64 bytes from 172.18.254.124: icmp_req=5 tt1=64 time=0.031 ms

64 bytes from 172.18.254.124: icmp_req=6 tt1=64 time=0.030 ms

64 bytes from 172.18.254.124: icmp_req=7 tt1=64 time=0.080 ms

64 bytes from 172.18.254.124: icmp_req=8 tt1=64 time=0.028 ms

64 bytes from 172.18.254.124: icmp_req=9 tt1=64 time=0.042 ms

--- 172.18.254.124 ping statistics ---

9 packets transmitted, 9 received, 0% packet loss, time 7998 ms

rtt min/avg/max/mdev=0.028/0.048/0.107/0.026 ms

The reported table from A2 to the MGMT VM will be (reporting the average values) A2

to

B1: 0.282

B2: 0.312

B3: 0.085

B4: 0.048

The above results illustrate the expected grouping of delays for the VMs that are collocated within the same data center (B3 and B4) and the “remote” VMs on a different data center (B1 and B2). By having such results, latency can be reduced through the selection of the VMs located within the same data center and/or having the lowest delay.

The examples above are based on the ping command; which can be scheduled to be started by all the VMs over the desired period of time (e.g. every 10 minutes), for example, and report back to the MGMT VM in order to update the routing table information. Note that the system can be configured to modify the frequency of the measurement and reporting interval based on the expected changes or system dynamics (e.g. by event detection or other methods).

In addition to the ping tool, example implementations can utilize the operation message exchange between the VMs to collect and monitor delay information. In an example implementations the B set of VMs forwards transactions and/or messages to the C set of VMs. One option for the delay monitoring is for the B set of VMs to add a field to the outgoing messages with the time stamp when the message was sent. Then the C type of VMs can copy the receive time stamp and also add the time stamp when acknowledge or return message is send back to the corresponding B set of VMs. With this information, all the B set of VMs can collect and report back the delay to the peer C set of VMs.

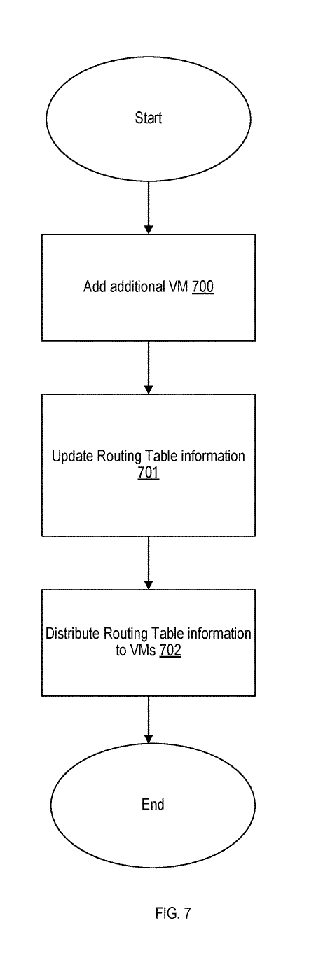

FIG. 7 illustrates a flow diagram for an addition of a VM, in accordance with an example implementation. At 700, a VM is added to the VNF by an administrator. Once the new VM is installed, the flow proceeds to 701 to update the routing table information, which can be implemented by having the MGMT VM request delay information from all of the VMs through the flow of FIG. 4 that have the added VM as a next peer. Once the flow of FIG. 4 is executed to account for the new VM, the MGMT VM distributes the updated routing table information to all VMs having the new VM as a peer at 702.

Turning to the example of FIG. 6, assume that the administrator newly installs VM C3, and that the routing table information for VM B3, which had only considered peers C1 and C2, has the routing table information of the following:

Next hop (peers):
Preferred peers
   C2
Alternate peers
   C1

In this example, the operator just instantiated a new VM of the type C, specifically C3, which is collocated in the same data center as the VM C2. After the instantiation of C3, the MGMT VM requests the B set VMs to perform the tracking of the delay and report back in accordance with FIG. 7. After B1 to B4 report back, the MGMT VM can provide the following update:

For B3 and B4:

Next hop (peers):
Preferred peers
   C2
   C3
Alternate peers
   C1

For B1 and B2:

Next hop (peers):
Preferred peers
   C1
Alternate peers
   C2
   C3

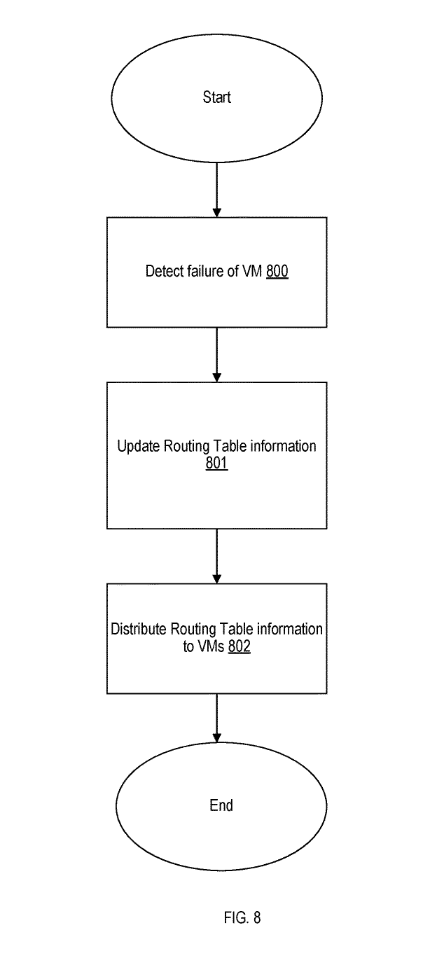

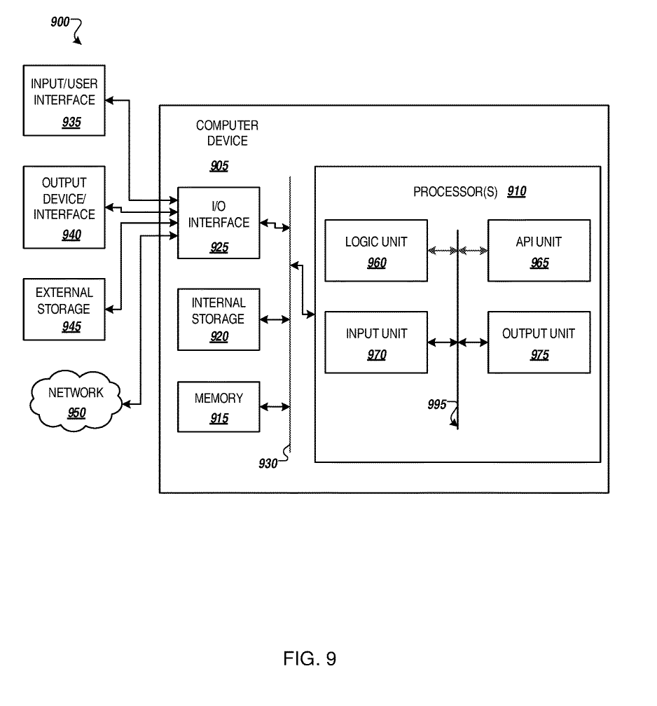

FIG. 8 illustrates a flow diagram for a VM failure, in accordance with an example implementation. At 800, a VM failure is detected by the MGMT VM through any method according to the desired implementation. The flow proceeds to 801 to update the routing table information, which can be implemented by removing the failed VM from the routing table information without needing to issue another request for delay information from related VMs. Once the flow of FIG. 4 is executed to account for the new VM, the MGMT VM distributes the updated routing table information to all VMs having the failed VM as a peer 803.

In the example of FIG. 6, assume that that there is a server failure and VM C2 is out of service. The watchdog timers and audits of the data center can detect the VM failure and report to the MGMT VM. As a result the MGMT VM will update the routing tables removing VM C2 from the peers in accordance with FIG. 8. As follows:

For B3 and B4:

Next hop (peers):
Preferred peers
   C3
Alternate peers
   C1

For B1 and B2:

Next hop (peers):
Preferred peers
   C1
Alternate peers
   C3

Note that for a failed VM, the MGMT VM can optionally collect delay information in accordance with a desired implementation, however the removal of the failed VM can be sufficient. The flow of FIG. 8 can also be utilized by the administrator to delete a VM from the VNF as desired. When the VM recovers, the VM can be added back to the VNF in accordance with FIG. 7.

In example implementations, there is an algorithm to measure and monitor delay between VMs within the VNF, and to measure and monitor delay between the VNF (I/O VMs) and the peer network functions. The algorithm can process, sort and produce “routing tables” for selection of closest distance or smaller delay for inter VM communication as well as peer network functions.

Through the example implementations sessions or services can be configured to the “closest” VMs based on the algorithm results. The example implementations facilitate the ability to move/rearrange sessions or services to the “closest” VMs based on the algorithm results.

FIG. 9 illustrates an example computing environment with an example computer device suitable for use in some example implementations. Computer device 905 in computing environment 900 can include one or more processing units, cores, or processors 910, memory 915 (e.g., RAM, ROM, and/or the like), internal storage 920 (e.g., magnetic, optical, solid state storage, and/or organic), and/or I/O interface 925, any of which can be coupled on a communication mechanism or bus 930 for communicating information or embedded in the computer device 905.

Computer device 905 can be communicatively coupled to input/user interface 935 and output device/interface 940. Either one or both of input/user interface 935 and output device/interface 940 can be a wired or wireless interface and can be detachable. Input/user interface 935 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 940 may include a display, television, monitor, printer, speaker, braille, or the like. In some example implementations, input/user interface 935 and output device/interface 940 can be embedded with or physically coupled to the computer device 905. In other example implementations, other computer devices may function as or provide the functions of input/user interface 935 and output device/interface 940 for a computer device 905.

Examples of computer device 905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 905 can be communicatively coupled (e.g., via I/O interface 925) to external storage 945 and network 950 for communicating with any number of networked components, devices, and systems, including one or more computer devices of the same or different configuration. Computer device 905 or any connected computer device can be functioning as, providing services of, or referred to as a server, client, thin server, general machine, special-purpose machine, or another label.

I/O interface 925 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, satellite network, and the like).

Computer device 905 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 910 can execute under any operating system (OS) (not shown), in a native or virtual environment. One or more applications can be deployed that include logic unit 960, application programming interface (API) unit 965, input unit 970, output unit 975, and inter-unit communication mechanism 995 for the different units to communicate with each other, with the OS, and with other applications (not shown). The described units and elements can be varied in design, function, configuration, or implementation and are not limited to the descriptions provided.

In some example implementations, when information or an execution instruction is received by API unit 965, it may be communicated to one or more other units (e.g., logic unit 960, input unit 970, output unit 975). In some instances, logic unit 960 may be configured to control the information flow among the units and direct the services provided by API unit 965, input unit 970, output unit 975, in some example implementations described above. For example, the flow of one or more processes or implementations may be controlled by logic unit 960 alone or in conjunction with API unit 965. The input unit 970 may be configured to obtain input for the calculations described in the example implementations, and the output unit 975 may be configured to provide output based on the calculations described in example implementations.

In example implementations, computer device 905 is configured to facilitate the functionality of an MGMT VM as described in the present disclosure as part of a cloud of devices to facilitate MGMT VM functionality. Memory 915, Internal storage 920 or External Storage 945 can be configured to store routing table information indicative of a plurality of interconnections between a plurality of VMs managed by the MGMT VM as illustrated in the examples of FIGS. 2 and 6, which can also be further indicative of a plurality of interconnections between a plurality of virtual machines (VMs) managed by the system and a peer network function as illustrated in FIGS. 2 and 5.

Processor(s) 910 can be configured to calculate latency for each of the plurality of interconnections of the plurality of VMs either receipt of ping delay information or through timestamps or by other desired implementations as described in FIGS. 4 and 6. Processor(s) 910 can be configured to select ones of interconnections from the plurality of interconnections for each of the plurality of VMs to utilize an interconnection based on a ranking of the latency through, for example, the sorting of interconnections by latency as illustrated in FIG. 4. Processor(s) 910 can then be configured to configure each of the plurality of VMs to utilize the selected ones of the plurality of interconnections by, for example, updating the routing table information at each of the VMs in accordance with FIG. 4, wherein the VMs will select the peer VM in the route with the lowest latency, or by direct instruction or other methods depending on the desired implementation.

Processor(s) 910 can also be configured to calculate the latency for each of the plurality of interconnections based on a retrieval of round trip time (RTT) for the plurality of interconnections or based on timestamps from messages between the plurality of VMs as illustrated in FIGS. 4 and 6. Processor(s) 910 can be configured to calculate the latency based on at least one of a predetermined period of time as described in FIG. 6 and a response to an event occurring on a VM from the plurality of VMs (e.g. upon detection of failure, addition/deletion of VM or other events as described in FIGS. 6-8).

On detection of a failure or a deletion of a first VM from the plurality of VMs, processor(s) 910 are configured to remove ones of interconnections from the plurality of interconnections associated with the first VM from the plurality of VMs in the routing table information as illustrated, for example, by the flows of FIG. 8. Further, on detection of an addition to or recovery of a second VM the plurality of VMs, processor(s) 910 are configured to add interconnections associated with the second VM to the routing table information as illustrated, for example, by the flows of FIG. 7.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A system, comprising:
a memory configured to store routing table information indicative of a plurality of interconnections between a plurality of virtual machines (VMs) managed by the system; and
a processor, configured to:
calculate latency for each of the plurality of interconnections of the plurality of VMs;
select ones of the plurality of interconnections for each of the plurality of VMs to utilize one of the interconnections based on a ranking of the latency; and
configure each of the plurality of VMs to utilize the selected ones of the plurality of interconnections.

2. The system of claim 1, wherein the processor is configured to calculate the latency for each of the plurality of interconnections based on a retrieval of round trip time (RTT) for the plurality of interconnections.

3. The system of claim 1, wherein the processor is configured to calculate the latency for each of the plurality of interconnections based on timestamps from messages between the plurality of VMs.

4. The system of claim 1, wherein the processor is configured to, on detection of a failure or a deletion of a first VM from the plurality of VMs, remove ones of interconnections from the plurality of interconnections associated with the first VM from the plurality of VMs in the routing table information; and
on detection of an addition to or recovery of a second VM the plurality of VMs, add interconnections associated with the second VM to the routing table information.

5. The system of claim 1, wherein the routing table information is further indicative of a plurality of interconnections between a plurality of virtual machines (VMs) managed by the system and an external node,
wherein the processor is further configured to:
calculate latency for each of the plurality of interconnections between the plurality of VMs and the external node;
for sessions initiated from a given external peer network function node, select, ones of the plurality of interconnections between the plurality of VMs and the external node to utilize one of the interconnections based on a ranking of the latency.

6. The system of claim 1, wherein the processor is configured to calculate the latency based on at least one of a predetermined period of time and a response to an event occurring on a VM from the plurality of VMs.

7. A method, comprising:
managing routing table information indicative of a plurality of interconnections between a plurality of virtual machines (VMs) managed by a system;
calculating latency for each of the plurality of interconnections of the plurality of VMs;
selecting ones of the plurality of interconnections for each of the plurality of VMs to utilize one of the interconnections based on a ranking of the latency; and
configuring each of the plurality of VMs to utilize the selected ones of the plurality of interconnections.

8. The method of claim 7, wherein the calculating the latency for each of the plurality of interconnections is based on a retrieval of round trip time (RTT) for the plurality of interconnections.

9. The method of claim 7, wherein the calculating the latency for each of the plurality of interconnections is based on timestamps from messages between the plurality of VMs.

10. The method of claim 7, further comprising:
on detection of a failure or a deletion of a first VM from the plurality of VMs, removing ones of interconnections from the plurality of interconnections associated with the first VM from the plurality of VMs in the routing table information; and
on detection of an addition to or recovery of a second VM the plurality of VMs, adding interconnections associated with the second VM to the routing table information.

11. The method of claim 7, wherein the routing table information is further indicative of a plurality of interconnections between a plurality of virtual machines (VMs) managed by the system and an external node,
wherein the method further comprises:
calculating latency for each of the plurality of interconnections between the plurality of VMs and the external node;
for sessions initiated from a given external peer network function node, selecting, ones of the plurality of interconnections between the plurality of VMs and the external node to utilize one of the interconnections based on a ranking of the latency.

12. The method of claim 7, further comprising calculating the latency based on at least one of a predetermined period of time and a response to an event occurring on a VM from the plurality of VMs.

13. A non-transitory computer readable medium, storing instructions for executing a process, the instructions comprising:
managing routing table information indicative of a plurality of interconnections between a plurality of virtual machines (VMs) managed by a system;
calculating latency for each of the plurality of interconnections of the plurality of VMs;
selecting ones of the plurality of interconnections for each of the plurality of VMs to utilize one of the interconnections based on a ranking of the latency; and
configuring each of the plurality of VMs to utilize the selected ones of the plurality of interconnections.

14. The non-transitory computer readable medium of claim 13, wherein the calculating the latency for each of the plurality of interconnections is based on a retrieval of round trip time (RTT) for the plurality of interconnections.

15. The non-transitory computer readable medium of claim 13, wherein the calculating the latency for each of the plurality of interconnections is based on timestamps from messages between the plurality of VMs.

16. The non-transitory computer readable medium of claim 13, the instructions further comprising:
on detection of a failure or a deletion of a first VM from the plurality of VMs, removing ones of interconnections from the plurality of interconnections associated with the first VM from the plurality of VMs in the routing table information; and
on detection of an addition to or recovery of a second VM the plurality of VMs, adding interconnections associated with the second VM to the routing table information.

17. The non-transitory computer readable medium of claim 13, wherein the routing table information is further indicative of a plurality of interconnections between a plurality of virtual machines (VMs) managed by the system and an external node,
wherein the instructions further comprises:
calculating latency for each of the plurality of interconnections between the plurality of VMs and the external node;
for sessions initiated from a given external peer network function node, selecting, ones of the plurality of interconnections between the plurality of VMs and the external node to utilize one of the interconnections based on a ranking of the latency.

18. The non-transitory computer readable medium of claim 13, the instructions further comprising calculating the latency based on at least one of a predetermined period of time and a response to an event occurring on a VM from the plurality of VMs.
